(19) United States
(12) Patent Application Publication
(10) Pub. No.: US 2025/0105741 A1
(43) Pub. Date: Mar. 27, 2025

(54) SEMICONDUCTOR INTEGRATED CIRCUIT DEVICE AND POWER SUPPLY DEVICE

(71) Applicant: ROHM CO., LTD., Kyoto (JP)

(72) Inventors: Takuo TAKAHASHI, KYOTO (JP); Tadashi AKAHO, Kyoto (JP)

(21) Appl. No.: 18/895,973

(22) Filed: Sep. 25, 2024

(30) Foreign Application Priority Data
Sep. 27, 2023 (JP) 2023-166336

(51) Int. Cl. H02M 3/158; H02M 1/00

(52) U.S. Cl. CPC H02M 3/158; H02M 1/0045

(57) ABSTRACT

A semiconductor integrated circuit device configured to be used as a part of a power supply device includes: an error amplifier configured to output an error voltage according to a difference between a feedback voltage, which is based on an output voltage of the power supply device, and a reference voltage; a first switching element and a second switching element that are connected in series; a first controller configured to control switching of the first switching element and the second switching element based on the error voltage; an output transistor; a second controller configured to linearly control the output transistor based on the error voltage; and a first terminal configured so that a connection node between the first switching element and the second switching element and an output terminal of the output transistor are connected to the first terminal.

### CROSS-REFERENCE TO RELATED APPLICATION

This application is based upon and claims the benefit of priority from Japanese Patent Application No. 2023-166336, filed on Sep. 27, 2023, the entire contents of which are incorporated herein by reference.

### TECHNICAL FIELD

The present disclosure relates to a semiconductor integrated circuit device and a power supply device.

### BACKGROUND

A semiconductor integrated circuit device in the related art includes a first error amplifier that outputs a first error voltage according to an error between a feedback voltage and a reference voltage, a second error amplifier that outputs a second error voltage according to an error between the feedback voltage and the reference voltage, a first switching element and a second switching element that are connected in series, a first controller that controls switching of the first switching element and the second switching element based on the first error voltage, an output transistor, and a second controller that linearly controls the output transistor based on the second error voltage.

The semiconductor integrated circuit device in the related art can be switched between using it as a part of a switching power supply device and using it as a part of a linear power supply device.

### BRIEF DESCRIPTION OF DRAWINGS

The accompanying drawings, which are incorporated in and constitute a part of the specification, illustrate embodiments of the present disclosure.

FIG. 1 is a diagram showing a schematic configuration of a semiconductor integrated circuit device according to a reference example.

FIG. 2 is a diagram showing a schematic configuration of a switching power supply device according to a reference example.

FIG. 3 is a diagram showing a schematic configuration of a linear power supply device according to a reference example.

FIG. 4 is a diagram showing a schematic configuration of a semiconductor integrated circuit device according to a first embodiment.

FIG. 5 is an external perspective view of the semiconductor integrated circuit device according to the first embodiment.

FIG. 6 is a diagram showing a schematic configuration of a switching power supply device according to the first embodiment.

FIG. 7 is a diagram showing a schematic configuration of a linear power supply device according to the first embodiment.

FIG. 8 is a diagram showing one configuration example of a phase compensation circuit.

FIG. 9 is a diagram showing a schematic configuration of a semiconductor integrated circuit device according to a second embodiment.

FIG. 10 is a diagram showing a schematic configuration of a semiconductor integrated circuit device according to a third embodiment.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

In this specification, the term MOSFET (Metal-Oxide-Semiconductor Field Effect Transistor) refers to a field effect transistor having a gate structure constituted by at least three layers of “a layer made of a conductor or a semiconductor such as polysilicon having a low resistance value,” “an insulating layer,” and “a P-type, N-type, or intrinsic semiconductor layer.” That is, the gate structure of the MOSFET is not limited to a three-layer structure of a metal, an oxide, and a semiconductor.

In this specification, the term reference voltage means a voltage that is constant under ideal conditions, but actually, refers to a voltage that may fluctuate slightly due to temperature changes and the like.

### <Semiconductor Integrated Circuit Device according to Reference Example>

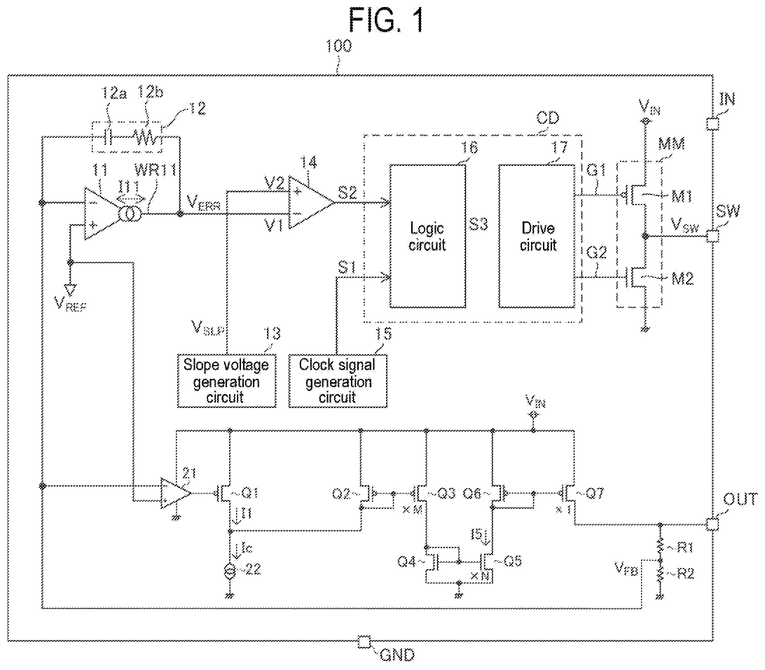

FIG. 1 is a diagram showing a schematic configuration of a semiconductor integrated circuit device according to a reference example. A semiconductor integrated circuit device 100 shown in FIG. 1 includes a terminal IN, a terminal SW, a terminal OUT, and a terminal GND. The terminal IN is a terminal configured to receive an input voltage V_{IN} outside the semiconductor integrated circuit device 100. The terminal GND is a terminal configured to be connected to a ground potential outside the semiconductor integrated circuit device 100.

The semiconductor integrated circuit device 100 further includes an output stage circuit MM, an error amplifier 11, a phase compensation circuit 12, a slope voltage generation circuit 13, a comparator 14, a clock signal generation circuit 15, a logic circuit 16, a drive circuit 17, and resistors R1 and R2.

The output stage circuit MM includes a transistor M1 configured as a P-channel MOSFET and a transistor M2 configured as an N-channel MOSFET. The transistors M1 and M2 are a pair of switching elements connected in series between the terminal IN and the terminal GND. When the transistors M1 and M2 are switched, the input voltage V_{IN} is switched and a switch voltage V_{SW} having a rectangular waveform appears at the terminal SW. The transistor M1 is provided on a higher potential side than the transistor M2. In other words, the transistor M2 is provided on a lower potential side than the transistor M1. Specifically, a source of the transistor M1 is connected to the terminal IN. A drain of the transistor M1 and a drain of the transistor M2 are commonly connected to the terminal SW. A source of the transistor M2 is connected to the terminal GND.

Gate signals G1 and G2 are supplied to gates of the transistors M1 and M2 as drive signals, respectively, and the transistors M1 and M2 are turned on and off in response to the gate signals G1 and G2. When the gate signal G1 is at a low level, the transistor M1 is turned on, and when the gate signal G1 is at a high level, the transistor M1 is turned off. When the gate signal G2 is at a high level, the transistor M2 is turned on, and when the gate signal G2 is at a low level, the transistor M2 is turned off. Basically, the transistors M1 and M2 are turned on and off alternately, but the transistors M1 and M2 may both be maintained in an off state. That is, a state of the output stage circuit MM is one of an output high state, an output low state, and a Hi-Z state (high impedance state).

The error amplifier 11 is a current output type transconductance amplifier. The error amplifier 11 has an inverting input terminal, a non-inverting input terminal, and an output terminal. The inverting input terminal of the error amplifier 11 receives a feedback voltage V_{FB}. The feedback voltage V_{FB} is a voltage obtained by dividing an output voltage V_{OUT} received at the terminal OUT by the resistors R1 and R2.

A predetermined reference voltage VREF is supplied to the non-inverting input terminal of the error amplifier 11. The reference voltage VREF is a DC voltage having a predetermined positive voltage value, and is generated by a reference voltage generation circuit (not shown) in the semiconductor integrated circuit device 100. The output terminal of the error amplifier 11 is connected to a wiring WR11.

The error amplifier 11 outputs a current signal I11 according to a difference between the feedback voltage V_{FB} and the reference voltage VREF from the output terminal thereof to generate an error voltage V_{ERR} according to the difference between the feedback voltage V_{FB} and the reference voltage VREF in the wiring WR11. Charges due to the current signal I11 are input and output with respect to the wiring WR11. Specifically, when the feedback voltage V_{FB} is lower than the reference voltage VREF, the error amplifier 11 outputs a current due to the current signal I11 from the error amplifier 11 to the wiring WR11 so that a potential of the wiring WR11 increases. When the feedback voltage V_{FB} is higher than the reference voltage VREF, the error amplifier 11 draws a current due to the current signal I11 from the wiring WR11 to the error amplifier 11 so that the potential of the wiring WR11 decreases. As an absolute value of the difference between the feedback voltage V_{FB} and the reference voltage VREF increases, a magnitude of the current due to the current signal I11 also increases.

The phase compensation circuit 12 is provided between the wiring WR11 and the inverting input terminal of the error amplifier 11 to receive the current signal I11 as an input to compensate a phase of the error voltage V_{ERR}. The phase compensation circuit 12 includes a series circuit of a capacitor 12a and a resistor 12b. Specifically, one end of the capacitor 12a is connected to the inverting input terminal of the error amplifier 11, the other end of the capacitor 12a is connected to one end of the resistor 12b, and the other end of the resistor 12b is connected to the wiring WR11. By appropriately setting a capacitance value of the capacitor 12a and a resistance value of the resistor 12b, it is possible to compensate the phase of the error voltage V_{ERR} and prevent oscillation of an output feedback loop.

The slope voltage generation circuit 13 generates and outputs a slope voltage V_{SLP}. The slope voltage V_{SLP} is a sawtooth voltage that is synchronized with a clock signal S1.

The comparator 14 has an inverting input terminal for receiving a voltage V1, a non-inverting input terminal for receiving a voltage V2, and an output terminal. The voltage V1 is a first comparison voltage, and the voltage V2 is a second comparison voltage. The comparator 14 compares the voltages V1 and V2, and outputs a signal S2 indicating the comparison result (hereinafter referred to as a comparison result signal S2) from the output terminal thereof. The comparison result signal S2 is a binary signal that takes a high or low signal level. The comparator 14 outputs a high-level comparison result signal S2 when “V2>V1” is satisfied (i.e., when the voltage V2 is higher than the voltage V1), and outputs a low-level comparison result signal S2 when “V2<V1” is satisfied (i.e., when the voltage V1 is higher than the voltage V2). When “V2=V1” is satisfied, the comparison result signal S2 is at a high or low level.

In the semiconductor integrated circuit device 100, the error voltage V_{ERR} functions as the voltage V1. That is, the inverting input terminal of the comparator 14 is connected to the wiring WR11 to receive the error voltage V_{ERR} as the voltage V1. In the semiconductor integrated circuit device 100, the slope voltage V_{SLP} functions as the voltage V2. That is, the non-inverting input terminal of the comparator 14 receives the slope voltage V_{SLP} as the voltage V2.

The clock signal generation circuit 15 generates and outputs the clock signal S1 having a predetermined frequency f_{pwM}.

The logic circuit 16 generates and outputs a control signal S3 based on the clock signal S1 and the comparison result signal S2. The control signal S3 is a binary signal that takes a high or low signal level.

The drive circuit 17 supplies the gate signals G1 and G2 to the gates of the transistors M1 and M2, respectively, in response to the control signal S3, thereby turning on or turning off the transistors M1 and M2 individually.

The logic circuit 16 and the drive circuit 17 constitute a drive control circuit CD that controls the output stage circuit MM based on the clock signal S1 and the comparison result signal S2.

The slope voltage generation circuit 13, the comparator 14, the clock signal generation circuit 15, and the drive control circuit CD constitute a first controller configured to control switching of the transistors M1 and M2 based on the error voltage V_{ERR}.

The semiconductor integrated circuit device 100 further includes an output transistor Q7 provided between the terminal IN and the terminal OUT, and a driver that drives the output transistor Q7 based on the difference between the feedback voltage V_{FB} and the reference voltage VREF.

The output transistor Q7 is a P-channel MOSFET. A source of the output transistor Q7 is connected to the terminal IN. A drain of the output transistor Q7 is connected to the terminal OUT.

The driver includes an error amplifier 21, a converter, a current amplifier, and a transistor Q6 configured as a P-channel MOSFET.

The error amplifier 21 outputs an error voltage according to the difference between the feedback voltage V_{FB} and the reference voltage VREF. The feedback voltage V_{FB} is supplied to an inverting input terminal of the error amplifier 21, and the reference voltage VREF is supplied to a non-inverting input terminal of the error amplifier 21. A power supply terminal of the error amplifier 21 is connected to the terminal IN.

The converter includes a transistor Q1 configured as a P-channel MOSFET, and converts a voltage into a current based on an output of the error amplifier 21. A gate of the transistor Q1 is connected to an output terminal of the error amplifier 21. A source of the transistor Q1 is connected to the terminal IN.

The current amplifier amplifies an output current of the transistor Q1. The current amplifier includes a constant current source 22, transistors Q2 and Q3 configured as P-channel MOSFETs, and transistors Q4 and Q5 configured as N-channel MOSFETs.

A first terminal of the constant current source 22 is connected to a drain of the transistor Q1, and a second terminal of the constant current source 22 is connected to the terminal GND.

The transistors Q2 and Q3 constitute a current source type current mirror circuit. Sources of the transistors Q2 and Q3 are connected to the terminal IN. Gates of the transistors Q2 and Q3 and a drain of the transistor Q2 are connected to the first end of the constant current source 22. A mirror ratio (a size of an output side transistor relative to a size of an input side transistor) of the current mirror circuit formed by the transistors Q2 and Q3 is M. In order to prevent a pole of the current mirror circuit formed by the transistors Q2 and Q3 from being shifted to a low band as much as possible, M may be 5 or less, and specifically, 3 or less.

The transistors Q4 and Q5 constitute a current sink type current mirror circuit. A drain of the transistor Q4 and gates of the transistors Q4 and Q5 are connected to a drain of the transistor Q3. Sources of the transistors Q4 and Q5 are connected to the terminal GND. A mirror ratio (a size of an output side transistor relative to a size of an input side transistor) of the current mirror circuit formed by the transistors Q4 and Q5 is N. In order to prevent a pole of the current mirror circuit formed by the transistors Q4 and Q5 from being shifted to a low band as much as possible, N may be 5 or less, and specifically, 3 or less.

An output current 15 of the current amplifier (a drain current of transistor Q5) is represented by the following formula using a drain current I1 of transistor Q1, a constant current Ic output from the constant current source, and the mirror ratios M and N:

15=M×N×(Ic−I1).

The transistor Q6, which is configured as a P-channel MOSFET, is provided between the current amplifier and the output transistor Q7. The transistor Q6 is paired with the output transistor Q7 to constitute a current source type current mirror circuit. A mirror ratio (a size of an output transistor relative to a size of an input transistor) of the current mirror circuit formed by the transistor Q6 and the output transistor Q7 is 1.

Gates of the transistor Q6 and the output transistor Q7 and a drain of the transistor Q6 are connected to a drain of the transistor Q5. A source of the transistor Q6 is connected to the terminal IN.

The converter, the current amplifier, and the transistor Q6 constitute a second controller configured to linearly control the output transistor Q7 based on the error voltage output from the error amplifier 21.

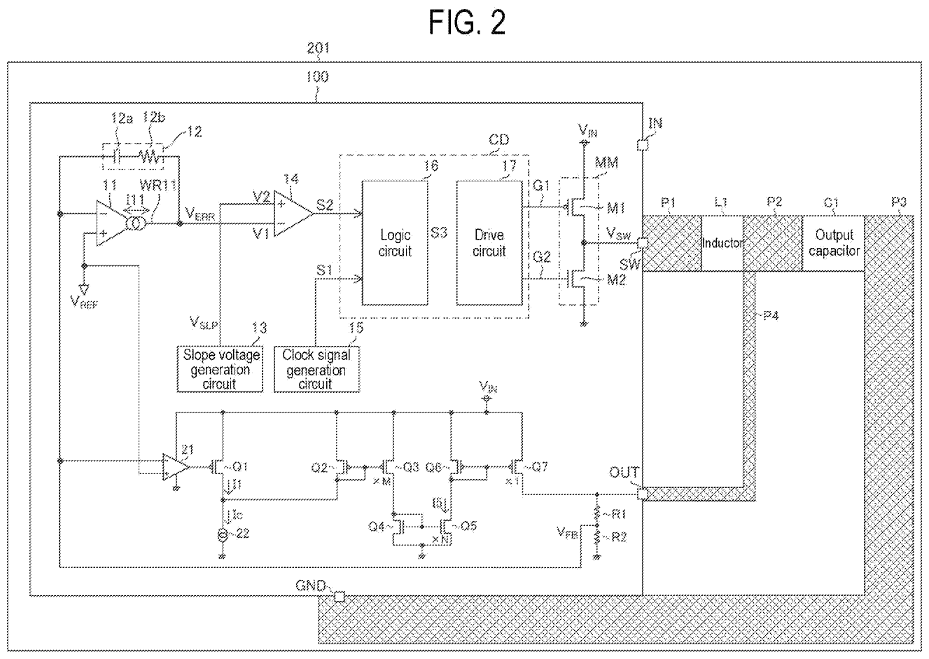

FIG. 2 is a diagram showing a schematic configuration of a switching power supply device according to a reference example. The switching power supply device shown in FIG. 2 includes a substrate 201, the semiconductor integrated circuit device 100 mounted on the substrate 201, an inductor L1 mounted on the substrate 201, and an output capacitor C1 mounted on the substrate 201.

In the switching power supply device shown in FIG. 2, the first controller is in an enabled state, and the second controller is in a disabled state.

The substrate 201 has wiring patterns P1 to P4. The wiring patterns P1 to P4 are made of a conductive material such as copper foil, aluminum foil, or the like. The wiring pattern P1 is a wiring pattern for electrically connecting the terminal SW and a first end of the inductor L1. The wiring pattern P2 is a wiring pattern for electrically connecting a second end of the inductor L1 and a first end of the output capacitor C1. The wiring pattern P3 is a wiring pattern for electrically connecting a second end of the output capacitor C1 and the terminal GND. The wiring pattern P4 is a wiring pattern for electrically connecting the wiring pattern P2 and the terminal OUT.

The wiring patterns P1 and P2 are wide wiring patterns that allow a large current to flow. On the other hand, since the wiring pattern P4 only needs to transmit voltage information, the wiring pattern P4 is a narrow wiring pattern.

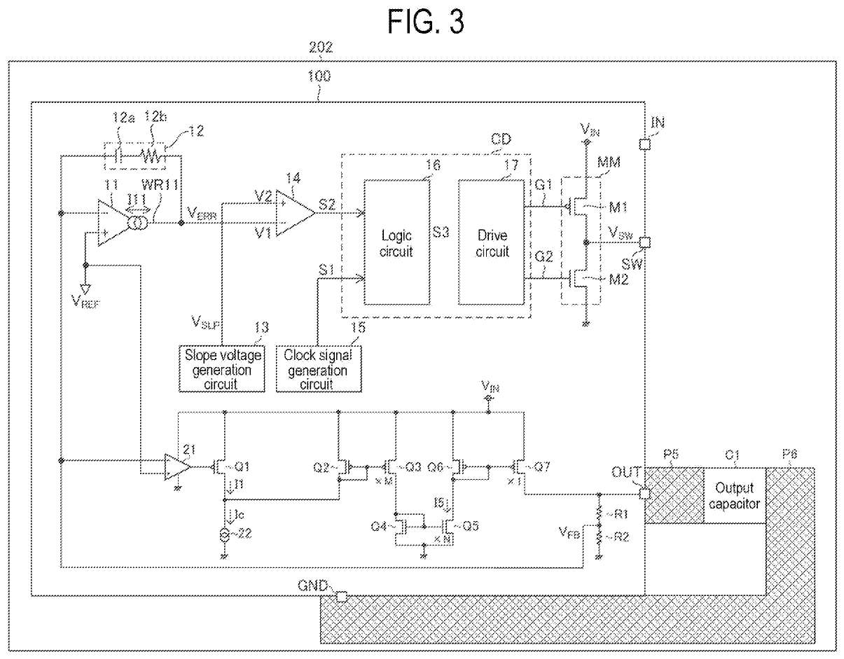

FIG. 3 is a diagram showing a schematic configuration of a linear power supply device according to a reference example. The linear power supply device shown in FIG. 3 includes a substrate 202, the semiconductor integrated circuit device 100 mounted on the substrate 202, and an output capacitor C1 mounted on the substrate 202.

In the linear power supply device shown in FIG. 3, the first controller is in a disabled state, and the second controller is in an enabled state.

The substrate 202 has wiring patterns P5 and P6. The wiring patterns P5 and P6 are made of a conductive material such as copper foil, aluminum foil, or the like. The wiring pattern P5 is a wiring pattern for electrically connecting the terminal OUT and a first end of the output capacitor C1. The wiring pattern P6 is a wiring pattern for electrically connecting a second end of the output capacitor C1 and the terminal GND.

The wiring pattern P5 is a wide wiring pattern that allows a large current to flow.

As described above, the wiring pattern of the substrate 201 used when the semiconductor integrated circuit device 100 is used as a part of the switching power supply device is different from the wiring pattern of the substrate 201 used when the semiconductor integrated circuit device 100 is used as a part of the linear power supply device. That is, when the semiconductor integrated circuit device 100 is used as a part of a power supply device, a substrate for switching power supply device and a substrate for linear power supply device cannot be made common. Therefore, when the semiconductor integrated circuit device 100 is used as a part of the power supply device, it takes time and effort to prepare the substrate for the switching power supply device and the substrate for the linear power supply device.

### First Embodiment

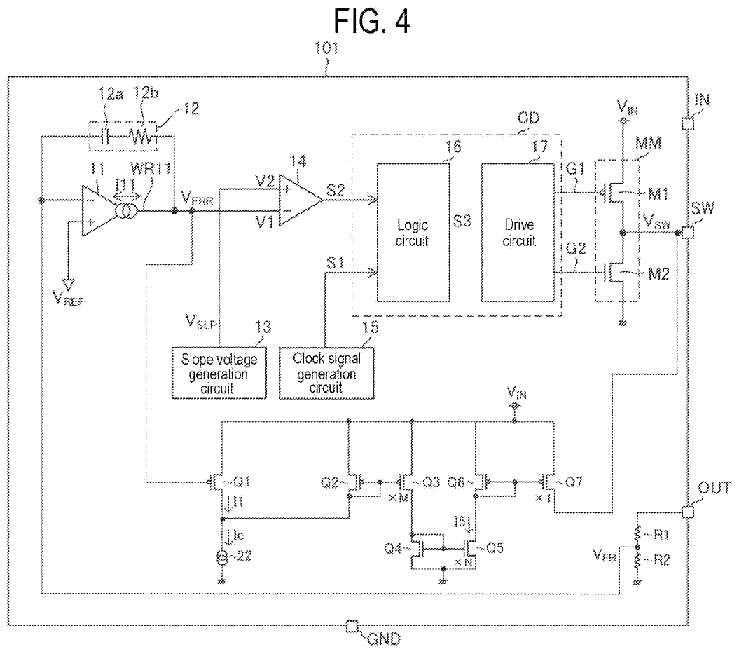

FIG. 4 is a diagram showing a schematic configuration of a semiconductor integrated circuit device according to a first embodiment. A semiconductor integrated circuit device 101 shown in FIG. 4 differs from the semiconductor integrated circuit device 100 shown in FIG. 1 in that the semiconductor integrated circuit device 101 does not include the error amplifier 21, the output terminal of the error amplifier 11 is connected to the gate of the transistor Q1, and the drain of the output transistor Q7 is connected to the terminal SW. In other respects, the semiconductor integrated circuit device 101 shown in FIG. 4 basically has the same configuration as the configuration of the semiconductor integrated circuit device 100 shown in FIG. 1.

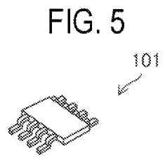

FIG. 5 is an external perspective view of the semiconductor integrated circuit device 101. The semiconductor integrated circuit device 101 is an electronic component that includes a semiconductor chip having a semiconductor integrated circuit formed on a semiconductor substrate, a case (package) for accommodating the semiconductor chip, and a plurality of external terminals exposed from the case to the outside of the semiconductor integrated circuit device 101. The semiconductor integrated circuit device 101 is formed by sealing the semiconductor chip in the case (package) made of resin. The number of external terminals of the semiconductor integrated circuit device 101 and the type of case for the semiconductor integrated circuit device 101 shown in FIG. 5 are merely an example, and may be designed arbitrarily.

In FIG. 4, only the terminal IN, the terminal SW, the terminal OUT, and the terminal GND are shown as a part of the plurality of external terminals provided on the semiconductor integrated circuit device 101. However, other external terminals (e.g., enable terminals, communication terminals, and the like) are also provided on the semiconductor integrated circuit device 101.

In the semiconductor integrated circuit device 101, both the first controller configured to perform a switching control and the second controller configured to perform a linear control perform the controls based on the error voltage V_{ERR} of the error amplifier 11, which makes it possible to reduce the number of error amplifiers. Thus, it is possible to improve area efficiency of the semiconductor integrated circuit device 101 as compared to area efficiency of the semiconductor integrated circuit device 100.

Since the semiconductor integrated circuit device 101 includes the terminal SW configured so that a connection node between the transistors M1 and M2 and the drain of the output transistor Q7 are connected to the terminal SW, the substrate for switching power supply device and the substrate for linear power supply device can be used in common.

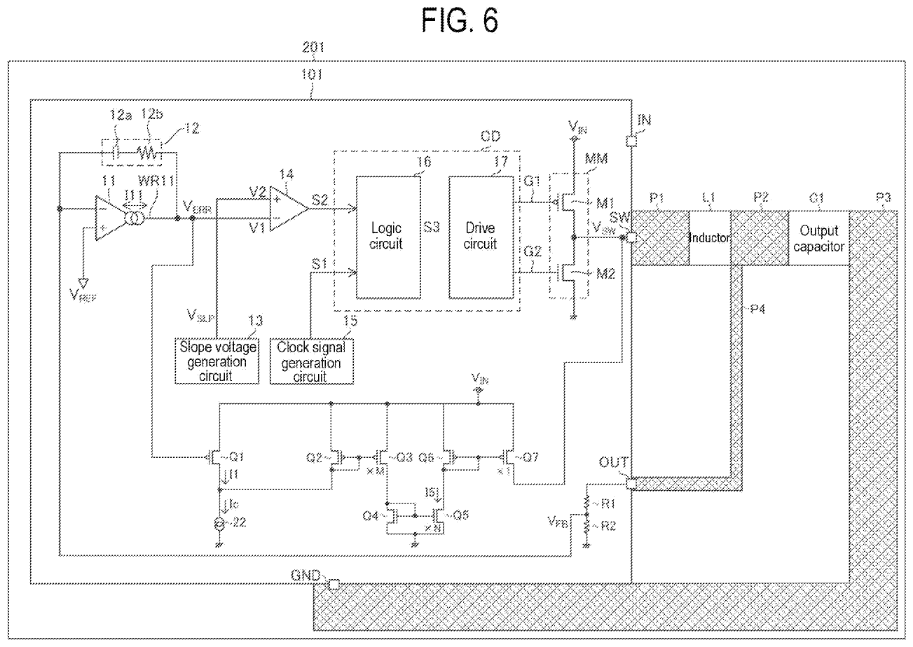

FIG. 6 is a diagram showing a schematic configuration of a switching power supply device according to the first embodiment. The switching power supply device shown in FIG. 6 includes a substrate 201, a semiconductor integrated circuit device 100 mounted on the substrate 201, an inductor L1 mounted on the substrate 201, and an output capacitor C1 mounted on the substrate 201.

In the switching power supply device shown in FIG. 6, the first controller is in an enabled state, and the second controller is in a disabled state.

The substrate 201 has wiring patterns P1 to P4. The wiring patterns P1 to P4 are made of a conductive material such as copper foil, aluminum foil, or the like. The wiring pattern P1 electrically connects the terminal SW and a first end of the inductor L1. The wiring pattern P2 electrically connects a second end of the inductor L1 and a first end of the output capacitor C1. The wiring pattern P3 electrically connects a second end of the output capacitor C1 and the terminal GND. The wiring pattern P4 electrically connects the wiring pattern P2 and the terminal OUT.

The wiring patterns P1 and P2 are wide wiring patterns that allow a large current to flow. On the other hand, since the wiring pattern P4 only needs to transmit voltage information, the wiring pattern P4 is a narrow wiring pattern.

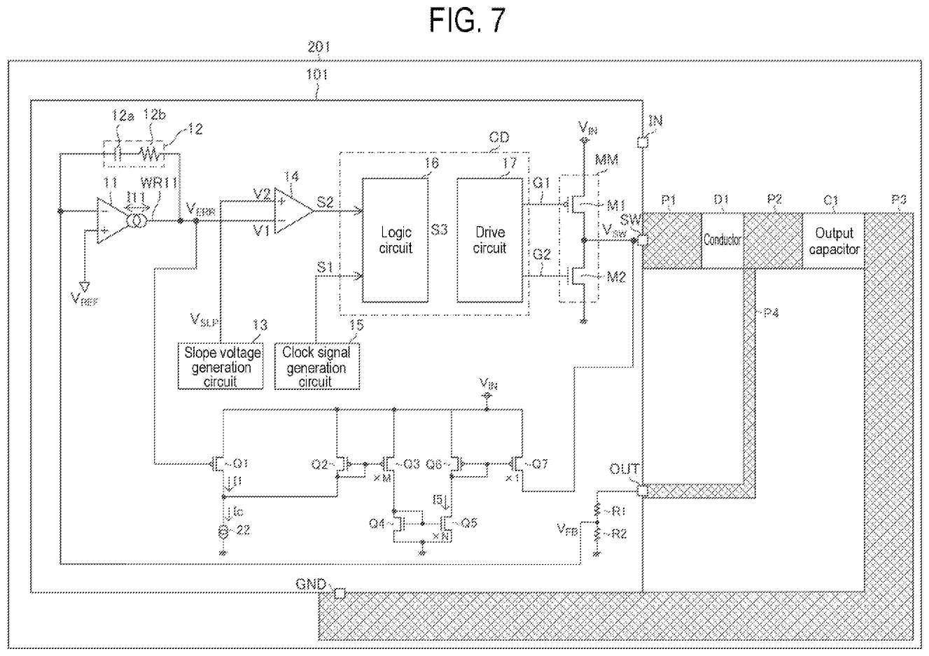

FIG. 7 is a diagram showing a schematic configuration of a linear power supply device according to the first embodiment. The linear power supply device shown in FIG. 7 includes a substrate 201, a semiconductor integrated circuit device 100 mounted on the substrate 201, a conductor D1 mounted on the substrate 201, and an output capacitor C1 mounted on the substrate 201. The conductor D1 is a discrete component having a resistance value of approximately 0 ohms.

In the linear power supply device shown in FIG. 7, the first controller is in a disabled state, and the second controller is in an enabled state.

The substrate 201 has wiring patterns P1 to P4. The wiring patterns P1 to P4 are made of a conductive material such as copper foil, aluminum foil, or the like. The wiring pattern P1 electrically connects the terminal SW and a first end of the conductor D1. The wiring pattern P2 electrically connects a second end of the conductor D1 and a first end of the output capacitor C1. The wiring pattern P3 electrically connects a second end of the output capacitor C1 and the terminal GND. The wiring pattern P4 electrically connects the wiring pattern P2 and the terminal OUT.

The wiring patterns P1 and P2 are wide wiring patterns that allow a large current to flow. On the other hand, since the wiring pattern P4 only needs to transmit voltage information, the wiring pattern P4 is a narrow wiring pattern.

As described above, when the semiconductor integrated circuit device 101 is used as a part of a power supply device, a substrate for a switching power supply device and a substrate for a linear power supply device can be made common. Therefore, when the semiconductor integrated circuit device 101 is used as a part of the power supply device, it does not take time and effort to prepare the substrate for the switching power supply device and the substrate for the linear power supply device.

In addition, at a stage of evaluating whether to use the semiconductor integrated circuit device 101 as a part of the switching power supply device or as a part of the linear power supply, it is desirable that the substrate for the switching power supply device and the substrate for the linear power supply can be made common as described above.

However, after the aforementioned evaluation is completed and the determination is made on whether the semiconductor integrated circuit device 101 will be used as a part of the switching power supply device or a part of the linear power supply device, a substrate dedicated to the switching power supply device or a substrate dedicated to the linear power supply device may be manufactured.

The substrate dedicated to the switching power supply device may have a configuration in which, for example, a wiring pattern having an inductor component, which has a first end electrically connected to the terminal SW via the wiring pattern P1 and a second end electrically connected to the wiring pattern P2, is added to the substrate 201. Thus, the inductor L1, which is a discrete component, becomes unnecessary.

The substrate dedicated to the linear power supply device may have a configuration in which, for example, a wiring pattern without having an inductor component, which has a first end electrically connected to the terminal SW via the wiring pattern P1 and a second end electrically connected to the wiring pattern P2, is added to the substrate 201. Thus, the conductor D1, which is a discrete component, becomes unnecessary. The expression “without having an inductor component” also includes a case where the inductor component is so small that it can be considered to be zero.

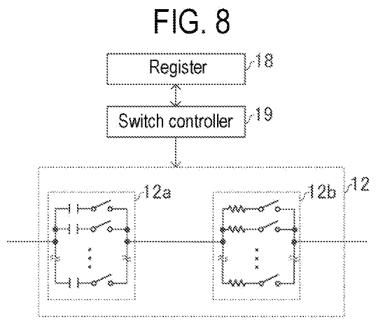

FIG. 8 is a diagram showing one configuration example of the phase compensation circuit 12. The phase compensation circuit 12 of the configuration example shown in FIG. 8 includes a plurality of capacitors corresponding to the capacitor 12a shown in FIG. 4 and a plurality of switches, and includes a plurality of resistors corresponding to the resistor 12b shown in FIG. 4 and a plurality of switches. The semiconductor integrated circuit device 101 includes a register 18 and a switch controller 19. The register 18 stores settings of the phase compensation circuit 12, specifically, on/off settings of each switch in the phase compensation circuit 12. The switch controller 19 controls on/off of each switch in the phase compensation circuit 12 based on the settings of the phase compensation circuit 12 stored in the register 18.

Since the number of error amplifiers is reduced, it is not necessary to provide the register 18 and the switch controller 19 for each of the error amplifiers. Therefore, area efficiency of a circuit portion relating to the phase compensation circuit 12 can be improved.

### Second Embodiment

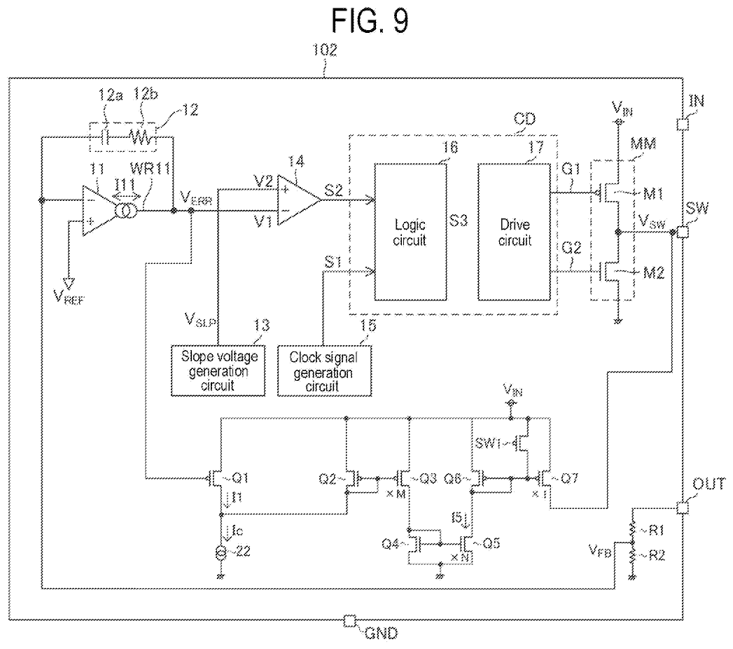

FIG. 9 is a diagram showing a schematic configuration of a semiconductor integrated circuit device according to a second embodiment. A semiconductor integrated circuit device 102 shown in FIG. 9 differs from the semiconductor integrated circuit device 101 shown in FIG. 4 in that the semiconductor integrated circuit device 102 includes a switch SW1 and a switch controller (not shown in FIG. 9) for controlling the switch SW1, but otherwise has basically the same configuration as that of the semiconductor integrated circuit device 101 shown in FIG. 4.

The switch SW1 switches on and off a short circuit between the gate and the source of the output transistor Q7. The switch SW1 is, for example, a P-channel MOSFET.

When the semiconductor integrated circuit device 102 is used as a part of the switching power supply device, the first controller is in an enabled state, the second controller is in a disabled state, and the switch SW1 is turned on. As a result, the gate and the source of the output transistor Q7 are short-circuited by the switch SW1. Thus, it is possible to prevent the output transistor Q7 from being turned on due to charging of a parasitic capacitance between the gate and the source of the output transistor Q7.

When the semiconductor integrated circuit device 102 is used as a part of the linear power supply device, the first controller is in a disabled state, the second controller is in an enabled state, and the switch SW1 is turned off.

### Third Embodiment

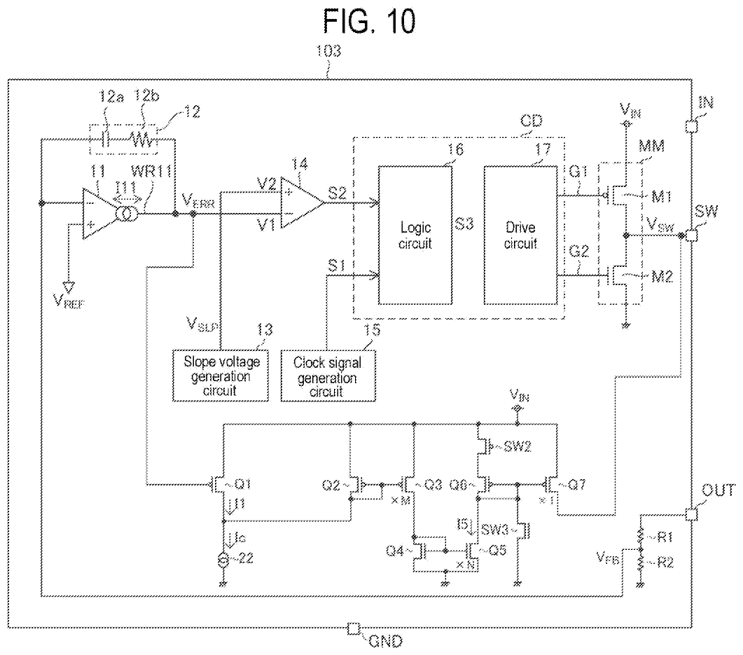

FIG. 10 is a diagram showing a schematic configuration of a semiconductor integrated circuit device according to a third embodiment. A semiconductor integrated circuit device 103 shown in FIG. 10 differs from the semiconductor integrated circuit device 101 shown in FIG. 4 in that the semiconductor integrated circuit device 103 includes switches SW2 and SW3 and a switch control (not shown in FIG. 10) for controlling the switches SW2 and SW3, but otherwise has basically the same configuration as that of the semiconductor integrated circuit device 101 shown in FIG. 4.

The switch SW2 is provided between the source of the transistor Q6 and the source of the output transistor Q7. The switch SW2 is, for example, a P-channel MOSFET.

The switch SW3 is provided between the gate of the transistor Q6 and the terminal GND. The switch SW3 is, for example, an N-channel MOSFET.

When the semiconductor integrated circuit device 103 is used as a part of the switching power supply device, the first controller is in an enabled state, the second controller is in a disabled state, the switch SW2 is turned on, and the switch SW3 is turned off.

When the semiconductor integrated circuit device 103 is used as a part of the linear power supply device, the first controller is in a disabled state, the second controller is in an enabled state, the switch SW2 is turned on, and the switch SW3 is turned off.

When the output transistor Q7 of the semiconductor integrated circuit device 103 is used as a load switch, the first controller is in a disabled state, the second controller is in an enabled state, the switch SW2 is turned off, and the switch SW3 is turned on. Since the switch SW2 is turned off, the gate of the output transistor Q7 is prevented from being clamped to a threshold voltage of the transistor Q6. Further, since the switch SW3 is turned on, the ground voltage is supplied to the gate of the output transistor Q7. As a result, the output transistor Q7 is fully turned on. Therefore, the output transistor Q7 can be used as a load switch.

### <Others>

In addition to the above-described embodiments, various modifications may be made to the configuration of the present disclosure without departing from the spirit of the present disclosure. The above-described embodiments should be considered to be exemplary in all respects and not limitative. The technical scope of the present disclosure is defined by the claims rather than the above description of the embodiments, and should be understood to include all modifications that are equivalent in meaning and scope to the claims.

For example, a diode having an anode connected to the terminal GND and a cathode connected to the drain of the transistor M1 may be used instead of the transistor M2. When the diode is used instead of the transistor M2, the first controller controls on/off switching of the diode by controlling a voltage of the terminal SW via a switching control for the transistor M1.

In addition, for example, the transistor M1 may be an N-channel MOSFET. When the transistor M1 is an N-channel MOSFET, a bootstrap circuit may be provided in the power supply device.

For example, in the above-described embodiments, the semiconductor integrated circuit device has built-in resistors R1 and R2, but the resistors R1 and R2 may be externally connected to the semiconductor integrated circuit device. In addition, the power supply device may have a configuration without having the resistors R1 and R2, and the feedback voltage V_{FB} may be the output voltage V_{OUT} of the power supply device itself, rather than a divided voltage of the output voltage V_{OUT} of the power supply device.

### <Supplementary Notes>

Regarding the present disclosure for which specific configuration examples have been shown in the above-described embodiments, supplementary notes will be provided.

A semiconductor integrated circuit device (101, 102, 103) of the present disclosure configured to be used as a part of a power supply device, includes: an error amplifier (11) configured to output an error voltage according to a difference between a feedback voltage, which is based on an output voltage of the power supply device, and a reference voltage; a first switching element (M1) and a second switching element (M2) that are connected in series; a first controller (13, 14, 15, CD) configured to control switching of the first switching element and the second switching element based on the error voltage; an output transistor (Q7); a second controller (Q1 to Q6, 22) configured to linearly control the output transistor based on the error voltage; and a first terminal (SW) configured so that a connection node between the first switching element and the second switching element and an output terminal of the output transistor are connected to the first terminal (first configuration).

According to the semiconductor integrated circuit device of the first configuration, both the first controller configured to perform a switching control and the second controller configured to perform a linear control perform the controls based on the same error voltage. Therefore, it is possible to reduce the number of error amplifiers. As a result, it is possible to improve the area efficiency of the semiconductor integrated circuit device.

In addition, since the semiconductor integrated circuit device of the first configuration includes the first terminal configured so that the connection node between the first switching element and the second switching element and the output terminal of the output transistor are connected to the first terminal, a substrate for switching the power supply device and a substrate for a linear power supply device can be made common.

The semiconductor integrated circuit device of the first configuration may further include a phase compensation circuit (12) configured to perform phase compensation for the error amplifier (second configuration).

The semiconductor integrated circuit device of the first or second configuration may further include a first switch (SW1) configured to switch on and off a short circuit between a gate and a source of the output transistor (third configuration).

The semiconductor integrated circuit device of any one of the first to third configurations may further include: a field effect transistor (Q6) paired with the output transistor to form a current mirror circuit; and a second switch (SW2) provided between a source of the field effect transistor and a source of the output transistor (fourth configuration).

The semiconductor integrated circuit device of the fourth configuration may further include a third switch (SW3) provided between a gate of the field effect transistor and a second terminal (GND) configured to receive a ground voltage (fifth configuration).

The semiconductor integrated circuit device of the fifth configuration may have a first operation mode in which the second switch is turned on and the third switch is turned off, and a second operation mode in which the second switch is turned off and the third switch is turned on (sixth configuration).

A power supply device of the present disclosure includes: a substrate (201); and the semiconductor integrated circuit device of any one of the first to sixth configurations mounted on the substrate (seventh configuration).

The power supply device of the seventh configuration further includes a wiring pattern having an inductor (L1) mounted on the substrate and electrically connected to the first terminal, or having an inductor component formed on the substrate and electrically connected to the first terminal (eighth configuration).

The power supply device of the seventh configuration further includes a wiring pattern having a conductor (D1) mounted on the substrate and electrically connected to the first terminal, or without having an inductor component formed on the substrate and electrically connected to the first terminal (ninth configuration).

While certain embodiments have been described, these embodiments have been presented by way of example only, and are not intended to limit the scope of the disclosures. Indeed, the embodiments described herein may be embodied in a variety of other forms. Furthermore, various omissions, substitutions, and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A semiconductor integrated circuit device configured to be used as a part of a power supply device, comprising:
an error amplifier configured to output an error voltage according to a difference between a feedback voltage, which is based on an output voltage of the power supply device, and a reference voltage;
a first switching element and a second switching element that are connected in series;
a first controller configured to control switching of the first switching element and the second switching element based on the error voltage;
an output transistor;
a second controller configured to linearly control the output transistor based on the error voltage; and
a first terminal configured so that a connection node between the first switching element and the second switching element and an output terminal of the output transistor are connected to the first terminal.

2. The semiconductor integrated circuit device of claim 1, further comprising a phase compensation circuit configured to perform phase compensation for the error amplifier.

3. The semiconductor integrated circuit device of claim 1, further comprising a first switch configured to switch on and off a short circuit between a gate and a source of the output transistor.

4. The semiconductor integrated circuit device of claim 1, further comprising:
a field effect transistor paired with the output transistor to form a current mirror circuit; and
a second switch provided between a source of the field effect transistor and a source of the output transistor.

5. The semiconductor integrated circuit device of claim 4, further comprising a third switch provided between a gate of the field effect transistor and a second terminal configured to receive a ground voltage.

6. The semiconductor integrated circuit device of claim 5, which has a first operation mode in which the second switch is turned on and the third switch is turned off, and
a second operation mode in which the second switch is turned off and the third switch is turned on.

7. A power supply device, comprising:
a substrate; and
the semiconductor integrated circuit device of claim 1 mounted on the substrate.

8. The power supply device of claim 7, further comprising a wiring pattern having an inductor mounted on the substrate and electrically connected to the first terminal, or having an inductor component formed on the substrate and electrically connected to the first terminal.

9. The power supply device of claim 7, further comprising a wiring pattern having a conductor mounted on the substrate and electrically connected to the first terminal, or without having an inductor component formed on the substrate and electrically connected to the first terminal.
